(19) United States
(12) Patent Application Publication
(10) Pub. No.: US 2005/0039201 A1
(43) Pub. Date: Feb. 17, 2005

(54) CD-ROM drive capable of rapidly installing and detaching

(75) Inventor: Hsin An Hsu, Taipei (TW)

Correspondence Address: BACON & THOMAS, PLLC, 625 SLATERS LANE, FOURTH FLOOR, ALEXANDRIA, VA, 22314, US

(73) Assignee: First International Computer, Inc., Taipei (TW)

(21) Appl. No.: 10/638,363

(22) Filed: Aug. 12, 2003

(51) Int. Cl. G11B 33/02

(52) U.S. Cl. 720/657

(57) ABSTRACT

The present invention is to provide a CD-ROM drive assembly capable of rapidly installing and detaching, which comprises a CD-ROM drive inserted into a slot of a case of a computer. The CD-ROM drive includes an elongated recess at a side and a plurality of apertures on a wall of the recess, and an elongated fastening mechanism having a plurality of holes aligned with the apertures so that a plurality of fasteners can be driven through the holes into the apertures for securing the fastening mechanism to the recess and for forming an assembly, and a first latch on a bottom being secured to a second latch inside the slot of the case. After the CD-ROM being fastened in the case, it only needs to disengage the first latch from the second latch prior to removing the CD-ROM drive from the case.

### FIELD OF THE INVENTION

The present invention relates to CD-ROM drive installation and removal and more particularly to a fastening mechanism being capable of rapidly installing a CD-ROM drive in a computer (e.g., notebook computer) and detaching the same from it.

### BACKGROUND OF THE INVENTION

This is an information age particularly an e-world as time evolves. Also, electronics industry and its associated industries have known a rapid, spectacular development. All kinds of high-technology products and communication products related to computer technology are commercially available. The fast development of the new products not only advantageously influences our daily life and work, but also brings a great convenience to people. In response to all kinds of new information products being developed, especially notebook computers, most users become more critical with respect to the convenience in using them. Thus, whether electronic products manufactured in the future can provide a more convenient and effective service to customers will be an indicator to decide whether sale revenue and manufacturing technology of one large electronic company are higher and more advanced than other competitive ones respectively.

For meeting the increasing consumer demand about computers, a high-technology company has to not only maintain good quality of its products, but also increase the manufacturing speed. In brief, each portion of an assembly line, whether important or not, will affect the manufacturing speed. For example, the speed of installing a CD-ROM drive in a computer is one of important factors that affect the increase of the computer assembly speed. It is understood that competition among computer manufacturing companies is very fierce. Thus, one computer manufacturing company cannot have a large share of the computer market if both the computer assembly speed of the company is low and quality of computers produced by the company is poor. To the worse, the company may be eliminated from the competitive computer market.

However, typically, a plurality of screws are employed to fasten a CD-ROM drive in the computer in the installation process. This has a drawback of low in assembly speed. Similarly, in a case of removing a malfunctioned CD-ROM drive for maintenance or replacement, a user has to sequentially detach the computer case, unfasten the screws by means of a screw driver, disconnect all power and data cables from the CD-ROM drive, and finally detach the CD-ROM drive from the computer case. As such, it is a tedious, time consuming, and labor intensive process during computer assembly. Similar drawbacks are also found in maintenance. This is an undesirable design. Further, it contradicts the trend of low cost, high efficiency, and mass production as pursued by modern industries.

Thus, it is desirable among vast consumers and computer manufacturers to provide a novel fastening mechanism capable of rapidly installing a CD-ROM drive in a computer and detaching the same from it in order to overcome the above drawbacks of the prior art.

### SUMMARY OF THE INVENTION

A primary object of the present invention is to provide a CD-ROM drive capable of rapidly installing and detaching for overcoming the above drawbacks of the prior art. These drawbacks are that a plurality of screws are employed to fasten a CD-ROM drive in the computer. For removing a malfunctioned CD-ROM drive, a user has to sequentially detach the computer case, unfasten the screws, disconnect all power and data cables from the CD-ROM drive, and finally detach the CD-ROM drive from the computer case.

One object of the present invention is to provide a CD-ROM drive assembly capable of rapidly installing and detaching, comprising a CD-ROM drive inserted into a slot of a case of a computer, the CD-ROM drive including an elongated recess at a side and a plurality of apertures on a wall of the recess; and an elongated fastening mechanism including a plurality of holes along a side wall, the holes being aligned with the apertures so that a plurality of fasteners can be driven through the holes into the apertures for securing the fastening mechanism to the recess and for forming an assembly, and a first latch on a bottom, the first latch being secured to a second latch inside the slot of the case when the assembly is fully inserted into the slot, thereby fastening the CD-ROM drive in the case; or the first latch being operative to press for disengaging from the second latch prior to removing the CD-ROM drive from the case.

The above and other objects, features and advantages of the present invention will become apparent from the following detailed description taken with the accompanying drawings.

### BRIEF DESCRIPTION OF THE DRAWINGS

FIG. 1 is a perspective view of a fastening mechanism according to the invention in which the mechanism is capable of rapidly installing a CD-ROM drive in a computer and detaching the same from it;

FIG. 2 is a perspective view of the mechanism mounted in the CD-ROM drive; and

FIG. 3 is a perspective view illustrating the installation of the CD-ROM drive in a notebook computer by means of the mechanism.

### DETAILED DESCRIPTION OF THE PREFERRED EMBODIMENTS

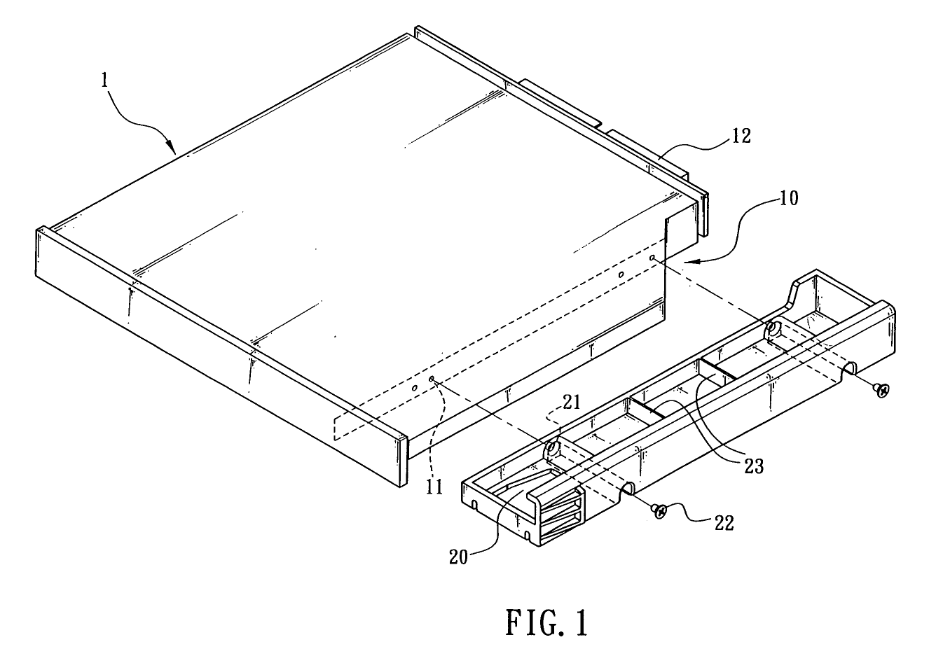

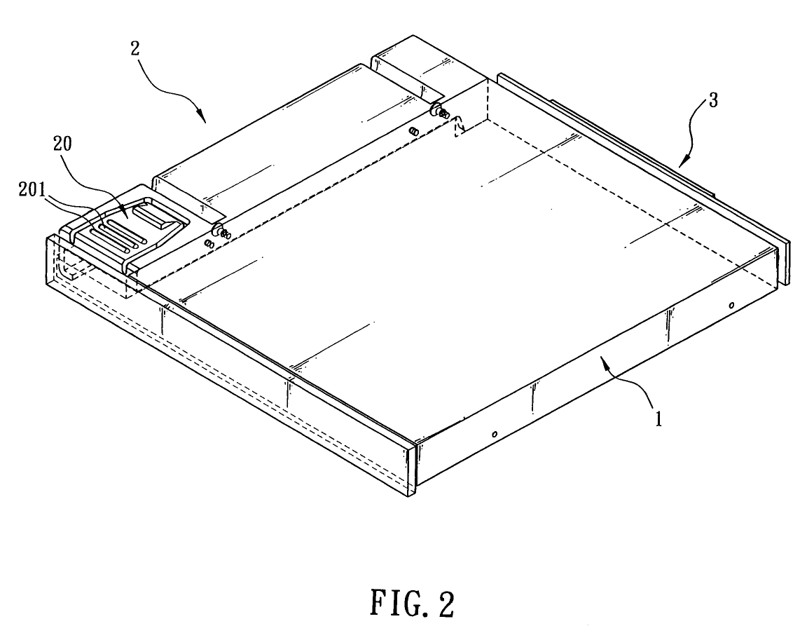

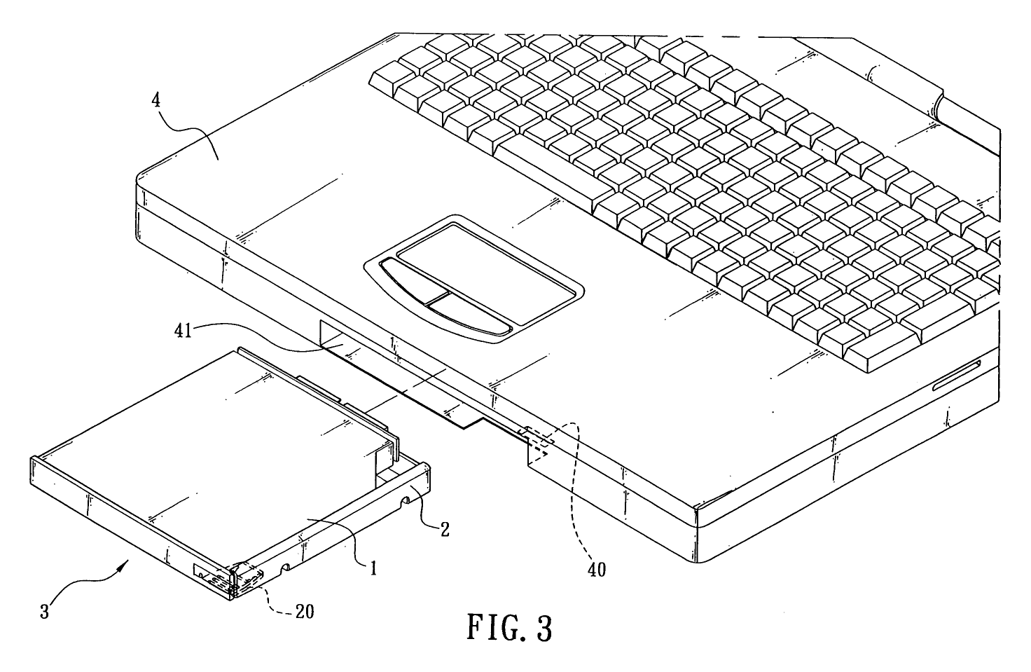

Referring to FIGS. 1, 2, and 3, there is shown a CD-ROM drive capable of rapidly installing and detaching in accordance with the invention. The invention comprises a CD-ROM drive 1 including an elongated recess 10 at a side and a plurality of apertures 11 on a wall of the recess 10; and an elongated fastening mechanism 2 including a first latch 20 on a bottom and a plurality of holes 21 along a side wall, the holes 21 being adapted to align with the apertures 11 so that a plurality of fasteners 22 can be driven through the holes 21 into the apertures 11 for securing the-fastening mechanism 2 to the recess 10. As an end, an assembly 3 is formed.

A computer comprises a front slot 41 conformed to the assembly 3. The first latch 20 is secured to a second latch 40 inside the slot 41 of the computer case 4 when the assembly 3 is fully inserted into the slot 41. As an end, the CD-ROM drive 1 is fastened in the computer case 4. To the contrary, a user can press the first latch 20 to disengage it from the second latch 40 prior to removing the CD-ROM drive 1 from the computer case 4. As a result, the purpose of rapidly detaching the CD-ROM drive 1 from the computer is achieved.

Referring to FIGS. 1 to 3 again, in the invention the fastening mechanism 2 comprises a plurality of parallel transverse ribs 23 spaced apart lengthwise. The ribs 23 are served as reinforcement for preventing the fastening mechanism 2 from being deformed when an external force is applied thereon. The fastening mechanism 2 further comprises a plurality of parallel ridges 201 on its surface. The ridges 201 are adapted to increase the traction between the assembly 3 and the skin of a technician or user who presses the ridges 201 for detaching the assembly 3 from the slot 41.

Referring to FIGS. 1 to 3 again, in the invention the CD-ROM drive 1 further comprises an input/output (I/O) connector 12 in the rear. The I/O connector 12 is coupled to a mated I/O connector (not shown) inside the computer case 4 when the CD-ROM drive 1 is fully inserted into the slot 41. As an end, a user can operate the computer to read data from the CD-ROM drive 1. The computer is implemented as a notebook computer in the embodiment.

In brief, the invention incorporates the above fastening mechanism for rapidly installing a CD-ROM drive 1 in a computer and detaching the same from the computer without employing a plurality of screws which, as stated in the background, is a tedious and time consuming process.

While the invention has been described by means of specific embodiments, numerous modifications and variations could be made thereto by those skilled in the art without departing from the scope and spirit of the invention set forth in the claims.

1. A CD-ROM drive assembly capable of rapidly installing and detaching, comprising:
a CD-ROM drive inserted into a slot of a case of a computer, the CD-ROM drive including an elongated recess at a side and a plurality of apertures on a wall of the recess; and
an elongated fastening mechanism disposed in the recess, the fastening mechanism including a plurality of holes along a side wall, the holes being aligned with the apertures so that a plurality of fasteners can be driven through the holes into the apertures for securing the fastening mechanism to the recess and for forming an assembly, and a first latch on a bottom,
wherein the first latch is secured to a second latch inside the slot of the case when the assembly is fully inserted into the slot, thereby fastening the CD-ROM drive in the case; or the first latch can be pressed for disengaging from the second latch prior to removing the CD-ROM drive from the case.

2. The CD-ROM drive assembly of claim 1, wherein the fastening mechanism further comprises a plurality of parallel transverse ribs spaced apart lengthwise, the ribs being adapted to strengthen the fastening mechanism for preventing the fastening mechanism from being deformed when an external force is applied thereon.

3. The CD-ROM drive assembly of claim 1, wherein the computer is a notebook computer.

4. The CD-ROM drive assembly of claim 1, wherein the fastening mechanism further comprises a plurality of parallel ridges on its surface.

5. The CD-ROM drive assembly of claim 1, wherein the CD-ROM drive further comprises an input/output (I/O) connector in a rear, the I/O connector being coupled to a mated I/O connector inside the case when the CD-ROM drive is fully inserted into the slot so that the computer is operative to read data from the CD-ROM drive.
